(19) United States
(12) Patent Application Publication
(10) Pub. No.: US 2003/0195793 A1
(43) Pub. Date: Oct. 16, 2003

(54) Automated online design and analysis of marketing research activity and data

(76) Inventors: Vivek Jain, New Delhi (IN); Parul A. Mittal, New Delhi (IN); Vikas Agarwal, New Delhi (IN)

Correspondence Address: McGinn & Gibb PLLC, 2568 A Riva Road, Suite 304, Annapolis, MD, 21401, US

(21) Appl. No.: 10/122,960

(22) Filed: Apr. 12, 2002

(51) Int. Cl. G06F 17/60

(52) U.S. Cl. 705/10

(57) ABSTRACT

This invention relates to a method, system and computer program product for automating the design of online marketing research activity, its deployment and the analysis and reporting of the obtained data, which comprises identifying the desired marketing research objectives, determining the marketing information required to meet said marketing research objectives, selecting the most appropriate research approach design, deciding the target group and costs for effectively deploying said marketing research approach design, deploying said marketing research approach design including dynamically modifying said research approach design and/or target group of participants, collecting and analyzing data, and reporting the findings.

### FIELD OF THE INVENTION

This invention relates to a method, system and program product for dynamic online automation of the design of Marketing Research activity, its deployment and the analysis and reporting of the data gathered from it. Marketing research may include one or more research approaches, e.g., marketing experiments, surveys, interviews, focus group discussions and the like.

### BACKGROUND OF THE INVENTION

Marketing research initiates from the problem that the merchant is trying to answer. The information required to address the problem is determined, the existing information and the available techniques are examined and the information gap is analyzed. Thereafter, a research approach is designed based on available data and analytical techniques to collect the missing information. The drawback is that this process is mostly manual and off-line in nature.

In the brick-and-mortar world, customer opinions and actions cannot be compared, since only aggregate data is available. Customers, whose opinions are collected, may not be contacted later to check whether they acted on the opinions expressed or if they behaved according to their disclosed preferences, and if they did not, what were the reasons. To overcome this problem, marketers have created panels of households who are paid regular incentives to disclose their preferences and product purchase information. The high cost of maintaining such a panel, however, limits the size and the scope of such studies.

Offering incentives as mentioned above is an established practice in marketing research. Often, like the marketing research process, the incentive determination is done manually and is not personalized for each participant.

On the other hand, even though the merchant can observe customer's actions on the Internet, he/she has no specific means of concluding about customer intentions. The merchant, therefore, tries to infer about preferences and opinions from customer's observed actions. Association rules and discovery of sequential patterns based on purchase data is one such attempt. These approaches have the limitation that they try to find patterns in the collected data and draw conclusions rather than answer a specific problem given by the merchant.

U.S. Pat. Nos. 5,893,098 and 6,175,833 have discussed the method and apparatus to conduct or-line customer surveys and opinion polls respectively. These methods are bound in the manner that they do automate the administration of customer surveys and opinion polls, but they do not automate the process of their design.

U.S. Pat. No. 6,195,646 describes a pricing model for selling information, pay per view, pay by the hour, etc., and dimensions along which the pricing model could be based.

### THE OBJECTS AND SUMMARY OF THE INVENTION

The object of the present invention is to overcome the above limitations by providing a method, system and program product to conduct the design process automatically and dynamically in an on-line environment.

The second object of the invention is to compare the value of information with the cost of acquisition to decide on the method and process of information acquisition.

Further objective of the invention is to control the parameters of the information.

Yet another objective of the invention is to have a method, system and program product to determine the value and type of incentives for each customer.

To achieve the said objectives this invention provides a method for automating the design of online marketing research activity, its deployment and the analysis and reporting of the obtained data comprising:

identifying the desired marketing research objectives,

determining the marketing information required to meet said marketing research objectives,

selecting the most appropriate research approach design,

deciding the target group and costs for effectively deploying said marketing research approach design,

deploying said marketing research approach design including dynamically modifying said research approach design and/or target group of participants,

collecting and analyzing data, and

reporting findings.

The said identification of desired marketing research objective is by selecting from predefined objectives and/or their combinations and or inter-relationships.

The said marketing information is determined by mapping each said objective to a set of data analysis techniques, identifying associated data requirement, determining which required information is not available in existing data repositories, and the desired format of such missing data.

The said research approach design is selected by choosing from a repository of research designs based on said marketing information, computed cost of deployment including cost of personalization and incentivisation, and value of marketing information to be obtained.

The said deployment is by adaptively adjusting the number and selection of participants and/or dynamically modifying said research design to suit an individual participant such that maximum information value is obtained at minimal cost.

The said predefined objectives include sales forecast, product preference test, advertising campaign effectiveness studies, new product acceptance and potential, pricing studies, study of business trends, desired feature enhancement to a product, market share analysis, studies of coupons, marketing campaign design, and market structure study to spot new opportunities.

The said data analysis techniques include conjoint analysis, segmentation using clustering based on attribute importance of product features, and collaborative filtering or demographic segmentation.

The above method includes an objective-technique map for using a supervised learning technique for analysis of participant information.

The above method includes incentive, utility and gain values for each participant associated with each said research design.

The said method includes the use of previous customer history of purchases, responses to research designs, click-stream information and any other available data.

The said incentivisation is based on the value of information from the customer and the cost of collection of said information including the cost of said incentive.

The above method includes selecting said participants based on cost of reaching the participant, cost of incentives offered to ensure participation, the probability of obtaining a response and the cost of analysing and using the information collected.

The above method includes the use of adaptive re-sampling technique for predicting a new participants' class and computing the uncertainty index for each participant as well as the total uncertainty index for all the participants.

The above method includes determining said incentives optimally, based on the history of said participants responses to said research designs, probability of said participant responding to a given incentive, value of information expected to be received and cost of conducting the research on said participant.

The participant selection is performed incrementally until a specified termination condition is reached.

The above method includes computation of the value of the information expected from said participant using Bayes decision theory to compute expected incremental payoff from each participant, the total expected payoff, and the decline in uncertainty.

The said mapping is performed iteratively with merchant interaction.

The said mapping is implemented using an incremental learning algorithm to improve output.

The said method uses a selected one or more out of a plurality of approaches to determine required data, said selection being performed by said merchant based on cost and merit of each approach.

The above method includes learning techniques for identifying desired marketing research objective, determining marketing information required, and selecting the most appropriate research approach design, based on findings and merchant feedback.

The said existing data repositories are available online either at all times or periodically or at specified time frames.

The said method incorporates participant preferences in responding to various research designs and/or participant profile as a basis for selection of participants including expected response time, previous history of purchases, usage of coupons, response to advertisements and research designs, click-stream information and any other participant specific information.

The above method incorporates the value of information as a function of the best prediction model from among several prediction models.

The said payoff is computed based on one or more repetitive game(s).

The said deployment is over multiple participant sets each set being determined by selection techniques.

The participant selection uses incremental learning algorithms and/or predictive techniques and/or learning tools to improve output.

The incentivisation uses incremental learning algorithms to improve output.

The above method uses a plurality of marketing research approach designs, a different marketing research approach design being used for each participant based on ranking according to expected gains.

The said termination condition is based on a threshold on uncertainty or rate of change of uncertainty or information value or rate of change of information value

The research approach design consists of one or a combination of an experimental design to study the response to an advertisement, coupon or product recommendation and/or classification of participants and/or survey(s).

The research approach design consists of a set of independent sub-sets of research approach designs.

The research approach design is deployed incrementally in stages with each stage consisting of one or more independent sub-sets.

The incentive offered to the participant is contingent on the timing of response and/or quality of response.

The present invention also provides a system for automating the design of online marketing research activity, its deployment and the analysis and reporting of the obtained data comprising:

marketing research objectives identification means,

marketing information requirement determination means to meet said marketing research objectives,

research approach design selection means,

target group selection means for effectively deploying said marketing research approach design,

deployment means for deploying said marketing research approach design including dynamically modifying said research approach design and/or target group of participants,

means for collecting and analyzing data, and

means for reporting findings.

The marketing research objective identification means is a merchant objective specification tool for selecting from predefined objectives or their combination and/or interrelationships.

The said requirement determination means is information requirement analysis tool for mapping each said objective to a set of data analysis techniques, identifying associated data requirements and determining which required information is not available in existing data repositories and the desired format of such missing data.

The said research approach design selection means is a research approach design selection tool for choosing from a repository of research designs based on said marketing information, computed cost of deployment including cost of personalization and incentivisation, and value of marketing information to be obtained.

The said deployment means is a mechanism for adaptively adjusting the number and selection of participants and/or dynamically modifying said research design to suit an individual participant such that maximum information value is obtained at minimal cost.

The said merchant objectives specification tool provides means for selecting from predefined objectives including sales forecast, product preference test, advertising campaign effectiveness studies, new product acceptance and potential, pricing studies, study of business trends, desired feature enhancement to a product, market share analysis, studies of coupons, marketing campaign design, and market structure study to spot new opportunities.

The said information requirement analysis tool incorporates a mechanism for implementing data analysis techniques including conjoint analysis, segmentation using clustering based on attribute importance of product features, and collaborative filtering or demographic segmentation.

The above system further includes a mechanism for implementing an objective map technique for using a supervised learning technique for analysis of participant information.

The above system includes means for associating incentive, utility and gain values for each participant with each said research design used.

The said system includes a mechanism for using previous participant history of purchases, responses to research designs, click-stream information and any other available data.

The above system includes means for determining said incentives based on the value of information from the participant and the cost of collection of said information including the cost of said incentive.

The above system further comprises mechanism for selecting said participants based on cost of reaching the participant, cost of incentives offered to ensure participation, the probability of obtaining a response and the cost of analysing and using the information collected.

The said system further comprises means for using adaptive resampling technique for predicting a new participants' class and computing the uncertainty index for each participant.

The above system further comprises mechanism for determining said incentives optimally, based upon the history of said participants responses to said research designs, probability of said participant responding to a given incentive, value of information expected to be received and cost of conducting the research on said participant.

The above system further includes means for incremental participant selection until a specified termination condition is reached.

The said system includes means for computing the value of the information expected from said participant using Bayes decision theory to compute expected incremental payoff from each participant, the total expected payoff, and the decline in uncertainty.

The said means for mapping is a mechanism that operates iteratively with merchant interaction.

The said means for mapping uses an incremental learning mechanism to improve output.

A selected one or more out of a plurality of approach means are used to determine required data, said approach means being selected by said merchant based on cost and merit of each approach.

The said system further includes learning means for identifying desired marketing research objective, determining marketing information required, and selecting the most appropriate research approach design, based on findings and merchant feedback.

The said existing data repositories are available online either at all times or periodically or at specified time frames.

The above system further includes means for incorporating participant preferences in responding to various research designs and/or participant profile as a basis for selection of participants including expected response time, previous history of purchases, usage of coupons, response to advertisements and research designs, click-stream information and any other participant specific information.

The above system further includes means for incorporating the value of information as a function of the best prediction model from among several prediction models.

The said system includes means for computing said payoff based on one or more repetitive game(s).

The above system further includes means for deploying said marketing research approach design over multiple participant sets each set being determined by selection techniques.

The said participant selection uses incremental learning means and/or predictive mechanism and/or learning tools to improve output.

The above system incorporates incremental learning means to improve incentivisation.

The said system includes a mechanism for using a plurality of marketing research approach designs, a different marketing research approach design being used for each participant based on ranking according to expected gains.

The said system further includes means for using a threshold on uncertainty or rate of change of uncertainty or information value or rate of change of information value for identifying said termination condition.

The research approach design consists of one or a combination of experimental designs to study the response to an advertisement, coupon or product recommendation and/or classification of participants and/or survey(s).

The said research approach design consists of a set of independent sub-sets of research approach designs.

The above system further includes means for deploying said research approach design incrementally in stages with each stage consisting of one or more independent sub-sets.

The incentive offered to the participant is contingent on the timing of response and/or quality of response.

The instant invention further provides a computer program product comprising computer readable program code stored on a computer readable storage medium embodied therein for automating the design of online marketing research activity, its deployment and the analysis and reporting of the obtained data comprising:

computer readable program code means configured for identifying the desired marketing research objectives,

computer readable program code means configured for determining the marketing information required to meet said marketing research objectives,

computer readable program code means configured for selecting the most appropriate research approach design,

computer readable program code means configured for deciding the target group and costs for effectively deploying said marketing research approach design,

computer readable program code means configured for deploying said marketing research approach design including dynamically modifying said research approach design and/or target group of participants,

computer readable program code means configured for collecting and analyzing data, and

computer readable program code means configured for reporting findings.

The said computer readable program code means configured for identifying the desired marketing research objectives is a merchant objective specification program code means for selecting from predefined objectives or their combination and/or interrelationships.

The said computer readable program code means configured for determining the marketing information is an information requirement analysis program code means for mapping each said objective to a set of data analysis techniques, identifying associated data requirements and determining which required information is not available in existing data repositories and the desired format of such missing data.

The said computer readable program code means configured for selecting the research approach design is research approach design tool program code means for choosing from a repository of research designs based on said marketing information, computed cost of deployment including cost of personalization and incentivisation, and value of marketing information to be obtained.

The said computer readable program code means configured for deploying is a program code means for adaptively adjusting the number and selection of participants and/or dynamically modifying said research design program code means to suit an individual participant such that maximum information value is obtained at minimal cost.

The said merchant objectives specification program code means is configured for selecting from predefined objectives including sales forecast, product preference test, advertising campaign effectiveness studies, new product acceptance and potential, pricing studies, study of business trends, desired feature enhancement to a product, market share analysis, studies of coupons, marketing campaign design, and market structure study to spot new opportunities.

The said information requirement analysis program code means is configured for implementing data analysis techniques including conjoint analysis, segmentation using clustering based on attribute importance of product features, and collaborative filtering or demographic segmentation.

The above computer program product includes computer readable program code means configured for implementing an objective map technique for using a supervised learning technique for analysis of participant information.

The above computer program product includes computer readable program code means configured for associating incentive, utility and gain values for each participant with each said research design program code means used.

The above computer program product further includes computer readable program code means configured for using previous participant history of purchases, responses to research designs program code means, click-stream information and any other available data.

The above computer program product further includes computer readable program code means configured for determining said incentives based on the value of information from the participant and the cost of collection of said information including the cost of said incentive.

The above computer program product further comprises computer readable program code means configured for selecting said participants based on cost of reaching the participant, cost of incentives offered to ensure participation, the probability of obtaining a response and the cost of analysing and using the information collected.

The above computer program product further comprises computer readable program code means configured for using adaptive resampling technique for predicting a new participants' class and computing the uncertainty index for each participant.

The above computer program product further comprises computer readable program code means configured for determining said incentives optimally, based upon the history of said participants responses to said research design program code means, probability of said participant responding to a given incentive, value of information expected to be received and cost of conducting the research on said participant.

The above computer program product further includes computer readable program code means configured for incremental participant selection until a specified termination condition is reached.

The above computer program product includes computer readable program code means configured for computing the value of the information expected from said participant using Bayes decision theory to compute expected incremental payoff from each participant, the total expected payoff, and the decline in uncertainty.

The said computer readable program code means configured for mapping is a mechanism that operates iteratively with merchant interaction.

The said computer readable program code means configured for mapping uses an incremental learning mechanism to improve output.

The above computer program product further incorporates program code means for selecting one or more out of a plurality of computer readable program code approach means configured for determining required data, said approach means being selected by said merchant based on cost and merit of each approach.

The above computer program product further includes computer readable program code learning means configured for identifying desired marketing research objective, determining marketing information required and selecting the most appropriate research approach design program code means, based on findings and merchant feedback.

The said existing data repositories are available online either at all times or periodically or at specified time frames.

The above computer program product further includes computer readable program code means configured for incorporating participant preferences in responding to various research designs and/or participant profile program code means as a basis for selection of participants wherein profile includes expected response time, previous history of purchases, usage of coupons, responses to advertisements and research designs, click-stream information and any other participant specific information.

The above computer program product further includes computer readable program code means configured for incorporating the value of information as a function of the best prediction model from among several production models.

The above computer program product includes computer readable program code means configured for computing said payoff based on one or more repetitive game(s).

The above computer program product further includes computer readable program code means configured for deploying said marketing research approach design program code means over multiple participant sets each set being determined by selection techniques.

The said program code means for participant selection uses incremental learning algorithms and/or predictive techniques and/or learning tools to improve output.

The said computer program product incorporates computer readable program code means configured to use incremental learning to improve incentivisation.

The plurality of marketing research approach design program code are used, a different marketing research approach design being used for each participant based on ranking according to expected gains.

The said computer readable program code means is configured for using a threshold on uncertainty or rate of change of uncertainty or information value or rate of change of information value for identifying said termination condition

The said research approach design program code means consists of one or a combination of experimental design program code means for studying the response to an advertisement, coupon or product recommendation and/or classification of customers and/or survey(s).

The said research approach design program code means consists of a set of independent sub-sets of research approach designs.

The said research approach design program code means is deployed incrementally in stages with each stage consisting of one or more independent sub-sets.

The above computer program product further includes program code means for offering said incentive to the participant contingent on the timing of response and/or quality of response.

### BRIEF DESCRIPTION OF THE DRAWINGS

The invention will now be described with reference to the accompanying drawings:

FIG. 1 is a flowchart giving an overview of Dynamic Online Marketing Research

FIG. 2 is a flowchart describing the operation of the Information Requirement Analysis Tool.

FIG. 3 is a flowchart describing the operation of the Research Approach Design Tool.

### DETAILED DESCRIPTION OF THE DRAWINGS

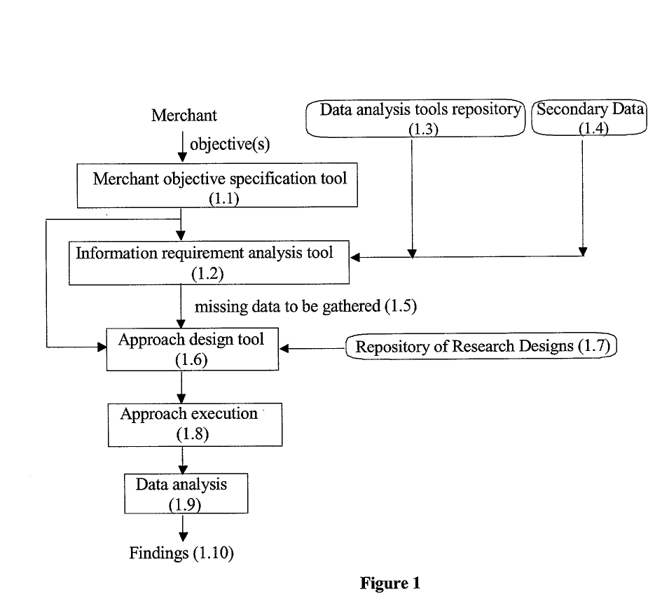

FIG. 1 represents an overview of Dynamic Online Marketing Research. The merchant specifies one or more objectives to be achieved by the system, using a Merchant objective specification tool (1.1). The information requirement analysis tool (1.2) takes as input the merchant objective(s), data analysis tool repository (1.3) and available secondary data (1.4), and determines the missing (primary) data to be gathered (1.5). The next step is to determine and design the approach to gather the primary data (1.6). This tool takes as input the repository of research designs (1.7). The research approach design tool outputs a set of approaches with associated incentive, utility and gain values. Merchant may be allowed to choose from this, or the system automatically chooses the approach that maximizes the total gain. Some part of the selected approach may be executed by the system in an on-line manner and the rest may be done by the merchant through off-line mechanism (1.8). The data collected is analyzed (1.9) and the findings (1.10) are presented to the merchant.

For the purpose of online marketing research, the merchant specifies a plurality of objectives to be achieved by the system, with the help of Merchant Objective Specification Tool (1.1). The objective could be sales forecast for a product, service or category of products, product preference tests, advertisement campaign effectiveness study, new product acceptance and potential, pricing studies, study of business trends in a particular market, desired feature enhancements to a product, market share analysis, studies of coupons, marketing campaign design, market structure study to spot new product opportunities, etc. The tool, as shown in FIG. 1, provides a graphical user interface to the merchant to specify the objective. The graphical user interface asks merchant to select one of the predefined objectives or a combination of these objectives with an interface to define interrelationships between each of the sub-objectives. For example, the objective of launching a new product can be broken down in sub-objectives of new product design, identification of the market segment, and finding the target customers for the new product.

The secondary data (1.4), as shown in FIG. 1, is the set of existing information from data banks, government publications, periodicals and books, third-party information resources, prior research reports, past transaction data, etc. It may comprise on-line as well as off-line data, for example, the secondary data may include one or more of the following:

Information about customer demographics, off-line sales transactions and off-line coupon usage records.

Online information on customer demographics, purchase history, coupon usage history, and click-stream.

Customer information regarding usage of products. For example, for a car, the mileage, condition of car at different points in time (say, at the time of servicing), its features, usage occasions, number of travelers in the car relative to the seating capacity.

History of customer responses to a research design including but not limited to, the presence or absence of response, quality of response and timing of response.

The data analysis tools repository (1.3) comprises of tools and techniques used for data mining, prediction, learning (supervised and unsupervised), classification, statistical analysis like multivariate regression, maximum likelihood functions, Bayesian estimators and neural network classifiers, analytical tools such as conjoint analysis, discriminant analysis, multidimensional scaling, perceptual maps and brand switching matrix.

The repository has information about input requirements, output result and the performance and/or predictive accuracy of each tool. The repository may also contain an initial map of merchant objectives and the techniques that can be used to achieve them. The mapping could be stored in the form of a database table, logical rules, decision tree or even a neural network.

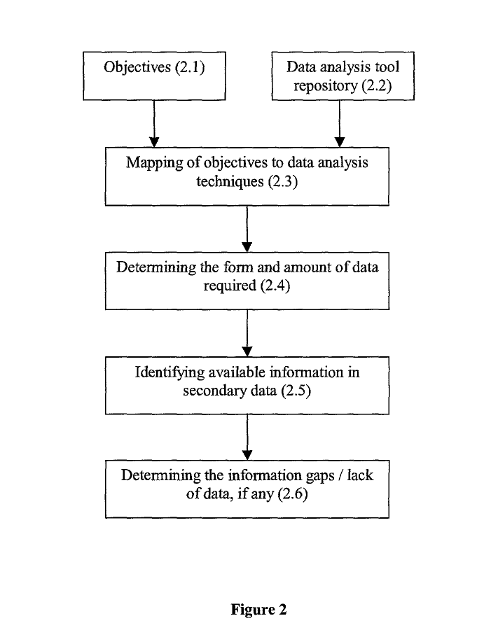

FIG. 2 gives a flowchart describing the operation of Information Requirement Analysis Tool (1.2). For each customer of interest, the information requirement analysis tool finds the missing data using the selected data analysis technique. The objective(s) (2.1) specified by the merchant is broken down into a set of sub-objectives such that each sub-objective can be mapped to a set of data analysis techniques (2.4), that are present in the data analysis tools repository (2.2). The objectives can be classified along different dimensions, for example, product category, product attributes, timing of purchase, time analysis (pre-purchase or post-purchase), old or new product. Several classification methods or learning algorithms, for example decision trees, can be used for this purpose.

For example, the objective of launching a new product can be broken down into sub-objectives as shown in Table 1. For each sub-objective, a data analysis can be selected using a mapping.

TABLE 1
Example of an objective-technique map

| Sub-objective | Data analysis technique |
|---|---|
| New product design | Conjoint Analysis |
| Identification of the market segment | Segmentation using clustering based on |
| | attribute importance of product features |
| Finding the target customers for the new | Collaborative filtering or demographic segmentation |
| product | |

The mapping is done using the objective-technique map available in the tools repository (2.2).

Next, the form and nature of data required by selected techniques to satisfy the merchant objectives is determined (2.4). This uses the input requirements, accuracy and output result information of each technique available in the tools repository. For example, conjoint analysis for new product design requires prospective customers' opinions about product features. The amount they are willing to pay for each additional attribute can be collected from a set of questions addressed to them or through the purchase transactions data. Each data analysis technique can only use specific data available in a pre-defined format. Desired level of accuracy for meeting the objective and performance/predictive accuracy of the analysis technique is used to determine the quantum of data required. Once the information required is determined, the system checks if the merchant's question can be answered with the existing set of data which includes secondary data (2.5). The existing information may not include the data set required for the selected data analysis tool, or the amount of data may be insufficient. If yes then the process is over. Then gaps in the information are determined (2.6). For example, if the merchant is planning to design a large campaign for coupons, the merchant may want to collect information about the behavior of customers for different coupon characteristics. The system decides using the objective-technique map to use a supervised learning technique such as a decision tree for analysis for customer information. The system discovers that the information is insufficient for a certain class of customers, say, high redemption customers. The merchant or the system may define a threshold on the number of redemptions in order for a customer to be classified as high coupon redeemer. The number of high redeemers may not be large or the variation in coupon redemption patterns may not be significant for a specific class of customers.

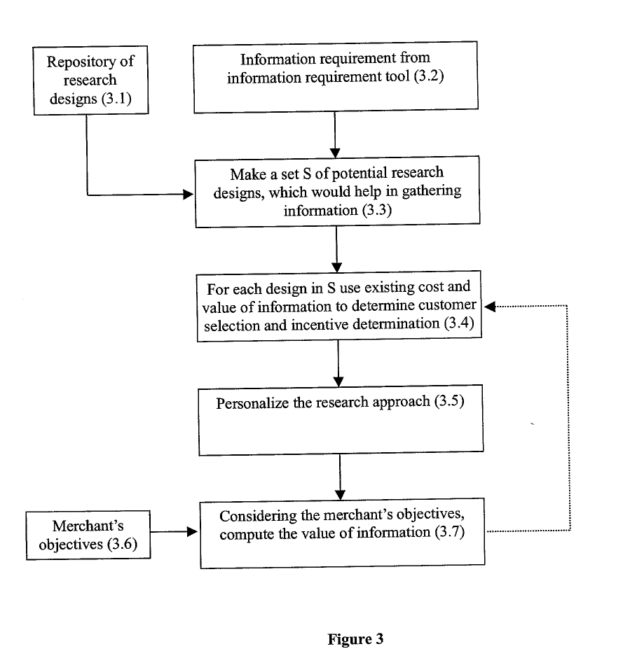

FIG. 3 gives a flowchart describing the operation of Research Approach Design Tool (1.6). The research approach design tool takes as input the information required (3.2), the research approach repository (3.1) and creates a set of one or more research designs (3.3), where each resultant design has an associated incentive, utility and gain values for each customer. For each potential research approach (3.4), using the existing set of information including customer profile, history of response to different designs and depending on the missing information, target customer selection is done, approach is personalized (3.5) and incentives are determined. Keeping in mind the merchant's objectives (3.6), the value of information is computed (3.7).

The customer selection and incentive determination (3.4), both use the value of information from the customer and the cost of collecting the information from the customer. The incentive for each customer affects the cost of information collection. Hence, an iterative loop may be required between customer selection and incentive determination before the final design. The final outcome is a set of approaches, targeted to a customer set, with associated incentive, utility, and gain values.

For a given a research design, the selection of participants (3.4) is done so that the required information can be gathered, with minimal cost.

The selection of participant customers is based on two parameters, the value of the information obtained from the customer and the cost incurred by including the customer in the approach design. The cost of the customer depends on the cost of reaching the customer Cᵣ (cost of an advertisement inviting participation), any incentive offered to ensure participation D, the probability of the customer responding and the cost of analyzing and using information collected Cₐ. The various costs can be computed using secondary data and merchant's domain knowledge. The participant customer selection evaluates the potential set of participants along these two parameters and selects the optimal set.

The accuracy of the research output increases incrementally with additional information gathered from each participant. The slope of the gain chart at any specific point specifies the increase in output accuracy with the added participant's information. In an instance, the optimal customer selection can be based on incremental adaptive resampling with an information theoretic criterion. The sample size is incrementally increased till the desired output accuracy is achieved. For example, the system may be able to map a given merchant objective to a customer classification problem. One such merchant objective can be determination of coupon discount value for each customer, where different discount values can be treated as different classes.

The system needs to design a research approach which, when applied to the customer, provides the correct class to which the customer belongs. The well-known adaptive re-sampling technique can be used as a potential research approach. The design of this research approach requires training of a committee of learners on different samples of the training data T, where T represents labeled customer data. Once the learners are trained on sample T, they can be used to predict a new customer's class using a majority rule. The prediction of each learner for the new customer is polled and an uncertainty index is computed. Given a training sample T, the total uncertainty is sum of the uncertainty indices for each customer. As the training sample is increased by δT, the total uncertainty declines.

$$Uncertainty index , {U}_{j , T} = , \frac{1 - {\sum }_{1 <= i <= L} ( {N}_{( i , j )} ) \hat{} 2}{K \hat{} 2} \qquad ( 1 )$$

Total classification uncertainty for sample T,

$${U}_{T} = {\sum }_{j} {U}_{j , T} for all customers j ∈ C , \qquad ( 2 )$$

Reduction in total classification uncertainty,

δU_{T}=U_{T}+δ_{T}−U_{T}, (3)

where

1. N_{(i,j)}=number of learners classifying the customer j as class “i”,

2. Number of learners, K is more than number of classes L, L<K, and

3.

$${\sum }_{1 <= i <= L} ( {N}_{( i , j )} ) = K , the total number of learners .$$

the total number of learners.

The system selects customers in order of declining δU_{T}. Thus, customer selection for this research approach design keeps adding customers to the selected set, till the termination condition is satisfied. For example, the merchant may specify a threshold on the uncertainty and/or the rate of change in uncertainty. The system may assume that decline in uncertainty relative to number of samples collected is a continuous curve and the slope of the curve at any instant provides an estimate for reduction in uncertainty for the next customer. For small value of T₁-T₂, the rate of decline of uncertainty is

$$\frac{δ {U}_{T}}{δ T} = \frac{{U}_{T1} - {U}_{T2}}{T1 - T2} \qquad ( 4 )$$

Incentive determination (3.4) involves determining the incentive, if any, to be offered to the customer to increase the probability and authenticity of his/her response. The objective is to determine a set of incentives for the customers so as to maximize the total expected gain from the information.

The tool may use one or more of the following parameters:

1. History of the customer responses to research design(s) including, but not limited to, the presence or absence of response, quality of response and timing of response.

2. Probability of the customer responding to the research design for a given incentive. This may depend on the history of the customer responses to research designs.

3. Value of the information from the customer.

4. Cost of conducting the research on the customer: The total cost of administering the research design is the cost of reaching the customer Cᵣ (cost of advertisement inviting participation), any incentive offered to ensure participation D, and the cost of analyzing and using information collected Cₐ.

For example, the optimization expression can be written as: Max G(j, D) over D for all customers j ∈ C.

Expected gain from customer j,

G(j, D)=R(j, D)*(information value−D−Cₐ)−Cᵣ (5)

where R (j, D) represents the probability of response of customer j, when he/she is offered an incentive D to participate in a research design.

Once the optimal incentive for each customer is computed, gain for the customer can be computed from Equation (5) above. The total gain from research approach is the sum of the gain from individual customers.

The approach is personalized (3.5) for the selected set of target customers. Personalization of research approach refers to the modification of the research design, i.e., the experiment, the survey questionnaire or campaign parameters to suit an individual customer, such that maximum information value with minimal inputs is obtained from the customer. It uses customer's previous purchase history, previous responses to research designs, click-stream information and any other available data for the purpose. For example, if the customer has already purchased the product, the research approach would remove the question about whether he/she has made a purchase or not. Instead the research design might focus on feedback, comparison with other products etc., depending on the merchant's objective.

For example, Table 2 represents a scenario of missing information and the potential research approach. Missing information from Joe, Jane and George can be collected either from responses to advertisement(s) or by specifically asking a survey question. Since surveys can handle larger number of attributes with relative ease, a survey might be the preferred research approach for Jane, and advertisements may be preferred for Joe and George. Also, advertisements shown to Maria may have different values of the attribute of the product but excluding the attribute value for which her preference is known.

TABLE 2
Missing information of a customer for a potential research approach

| Customer | Missing information | Potential research approach |
|---|---|---|
| Joe | Importance of 2 | Response to an advertisement highlighting the two |
| | product attributes | attributes |
| Jane | Importance of 4 | Survey question with attribute names and rating on a |
| | product attributes | 10-point scale |
| George | Importance of 1 | Response to an advertisement highlighting the attribute |
| | attribute | |
| Maria | Preferred value of an | Response to an advertisements highlighting product |
| | attribute | with specific value of that attribute. |
| Jack | Product usage behavior | Survey question with different usage occasions with the |
| | | option “Other than mentioned here (please specify)”. |
| Senorita | Product purchase | Survey question depicting steps in purchase process in |
| | process | which respondent is asked to pick the option that |
| | | closely resembles his/her process. |
| Nicholas | Inclination to buy | Response to an advertisement of a similar product or |
| | | the new product. |

The value or the utility of information (3.7) depends on the nature and the content of information, the customer from whom it is received and what action the merchant proposes to take based on the information. The merchant's objective function therefore, plays a significant role in determining the value of information. In the preferred embodiment of this invention, Bayes decision theory is used to compute the value of information. The value of information is equivalent to {value of action taken with the information} less {the value of action taken without the information}. The value of information from the customer can be computed by constructing a payoff matrix of possible merchant actions with and without the information. The payoff matrix is a game theoretic representation of interaction between the customer and the merchant.

For the merchants objective, the decision about different discount values impacts the purchase decision of the customer for a particular product. Say there are L discount classes with discount values m₁, m₂, m₃, . . . m_{L}, arranged in order of increasing value. Our hypothesis is that if customer j truly belongs to class i, he/she would redeem any coupon of value more than mᵢ and purchase the product. If the customer is offered a discount lower than mᵢ, he/she would not purchase the product. The system can assume without loss of generalization that coupons are arranged in increasing order of discount value, i.e., mᵢ<mᵢ₊₁, for all values of i, 1<=i<=L. Given a training sample T, the system constructs a payoff matrix π_{i,j,T} for each merchant action as shown in Table 3.

TABLE 3
Pay-off matrix for the merchant (without repetition)

| | | Correctly | |
|---|---|---|---|
| | Incorrectly | classified class I = | Incorrectly classified |
| | classified class I < Io | Io | class I > Io |
| Product sales | No sale | Sale | Sale |
| Coupon redeemed | No | Yes | Yes |
| Cost of distribution | Cd | Cd | Cd |
| Cost of redemption | R | R | |
| Merchant's profit | -C_{d} | Margin - (C_{d} + R)- | Margin - (C_{d + R)-m}ᵢ |
| | | mᵢ | |

At any given set of information, the system classifies each customer j ∈C in class i, where 1<=i<=L. The uncertainty index gives the accuracy of prediction. To maximize the merchant's payoff, the system computes the best course of action specific to a customer. The following set of equations represent the payoffs,

Maximize Expected payoff,

$${π}_{j , T} = {\sum }_{1 <= i <= L} {P}_{i , j , {T}^{*}} {π}_{i , j , T} \qquad ( 6 )$$

where

$${P}_{i , j , T} = \frac{{N}_{i , j , T}}{K} ,$$

fraction of learners classifying the customer j as class i.

Total expected payoff,

$${π}_{T} = {\sum }_{j π j , T} ( max ) \qquad ( 7 )$$

Incremental increase in payoff,

δπ_{T}=π_{T}+δ_{T}−π_{T} (8)

Based on a decision for each customer, the total expected payoff, as in Equation (7), is computed. To each customer j ∈C, the system computes incremental payoff δπ_{T} and decline in uncertainty δU_{T}.

Target participant selection may also be based on a preference of participants who are opinion leaders or customers who have large influence on other customers. Customers, for whom the pattern of purchase behavior precedes other customers in time, are classified as opinion leaders or trendsetters. Pattern recognition in time is a well-researched field and such patterns can be easily identified.

Target participant selection can also be based on the expected response time of the participant in determining customer cost. It is quite possible that some customers may not log into the site for a long time, resulting in a long time lag in data collection.

The research approach repository (1.7) comprises a plurality of experiment designs and survey questionnaires. Associated with each approach is input requirement and information about what the approach can gather. Different research approaches such as experiments and/or surveys can be used to collect the missing information. The research approach could be one or a combination of the following forms:

An experimental design to study the response to an advertisement, coupon or product recommendation

Classification of customers

Survey

The experiment and/or a survey can in turn consist of a set of smaller experiments and/or surveys.

Each research approach can be characterized by a plurality of parameters. For example, survey queries can be classified based on a set of characteristics. We can define characteristics in terms of the type of information and form of query. Type of information refers to attitudinal information, product preference, top of the mind brand recall, most purchased brand, etc. Form of query refers to the form of questions, open ended questions, multiple choice, multiple choice with “none of the above” and a form for text entry, and rating and ranking scale of data.

This complete set of information about research approaches, their input and output parameters is a part of the repository.

The selected research approach may be executed in different ways. For example, in a survey, there can be two ways of giving the questions to the user. a) All the questions are given to the user in one single form. b) The questions are presented to the user one at a time. At each stage he can choose to either continue answering or quit. Here the next question may be based on the answer given for the previous question. In this case the number of questions asked to a user can be decreased and more useful information can be captured.

The research approach parameters such as the value of the participant incentive may change during the approach execution or participant may receive the incentive only if he/she answers all survey questions.

Further, the participant in an experiment and/or a survey may or may not be made aware of what incentive he/she has earned until the end of execution.

1. A method for automating the design of online marketing research activity, its deployment and the analysis and reporting of the obtained data comprising:
identifying the desired marketing research objectives,
determining the marketing information required to meet said marketing research objectives,
selecting the most appropriate research approach design,
deciding the target group and costs for effectively deploying said marketing research approach design,
deploying said marketing research approach design including dynamically modifying said research approach design and/or target group of participants,
collecting and analyzing data, and
reporting findings.

2. A method as claimed in claim 1, wherein said identification of desired marketing research objective is by selecting from predefined objectives and/or their combinations and/or inter-relationships.

3. A method as claimed in claim 1, wherein said marketing information is determined by mapping each said objective to a set of data analysis techniques, identifying associated data requirement, determining which required information is not available in existing data repositories, and the desired format of such missing data.

4. A method as claimed in claim 1, wherein said research approach design is selected by choosing from a repository of research designs based on said marketing information, computed cost of deployment including cost of personalization and incentivisation, and value of marketing information to be obtained.

5. A method as claimed in claim 1, wherein said deployment is by adaptively adjusting the number and selection of participants and/or dynamically modifying said research design to suit an individual participant such that maximum information value is obtained at minimal cost.

6. A method as claimed in claim 2, wherein said predefined objectives include sales forecast, product preference test, advertising campaign effectiveness studies, new product acceptance and potential, pricing studies, study of business trends, desired feature enhancement to a product, market share analysis, studies of coupons, marketing campaign design, and market structure study to spot new opportunities.

7. A method as claimed in claim 3, wherein said data analysis techniques include conjoint analysis, segmentation using clustering based on attribute importance of product features, and collaborative filtering or demographic segmentation.

8. A method as claimed in claim 3 including an objective-technique map for using a supervised learning technique for analysis of participant information.

9. A method as claimed in claim 4 including incentive, utility and gain values for each participant associated with each said research design.

10. A method as claimed in claim 4 including the use of previous customer history of purchases, responses to research designs, click-stream information and any other available data.

11. A method as claimed in claim 4, wherein said incentivisation is based on the value of information from the customer and the cost of collection of said information including the cost of said incentive.

12. A method as claimed in claim 5 including selecting said participants based on cost of reaching the participant, cost of incentives offered to ensure participation, the probability of obtaining a response and the cost of analysing and using the information collected.

13. A method as claimed in claim 5 including the use of adaptive re-sampling technique for predicting a new participants' class and computing the uncertainty index for each participant as well as the total uncertainty index for all the participants.

14. A method as claimed in claim 5 including determining said incentives optimally, based on the history of said participants responses to said research designs, probability of said participant responding to a given incentive, value of information expected to be received and cost of conducting the research on said participant.

15. A method as claimed in claim 5, wherein participant selection is performed incrementally until a specified termination condition is reached.

16. A method as claimed in claim 5 including computation of the value of the information expected from said participant using Bayes decision theory to compute expected incremental payoff from each participant, the total expected payoff, and the decline in uncertainty.

17. A method as claimed in claim 3, wherein said mapping is performed iteratively with merchant interaction.

18. A method as claimed in claim 3, wherein said mapping is implemented using an incremental learning algorithm to improve output.

19. A method as claimed in claim 3 using a selected one or more out of a plurality of approaches to determine required data, said selection being performed by said merchant based on cost and merit of each approach.

20. A method as claimed in claim 1 including learning techniques for identifying desired marketing research objective, determining marketing information required, and selecting the most appropriate research approach design, based on findings and merchant feedback.

21. A method as claimed in claim 3, wherein said existing data repositories are available online either at all times or periodically or at specified time frames.

22. A method as claimed in claim 5 incorporating participant preferences in responding to various research designs and/or participant profile as a basis for selection of participants wherein profile includes expected response time, previous history of purchases, usage of coupons, response to advertisements and research designs, click-stream information and any other participant specific information.

23. A method as claimed in claim 5 incorporating the value of information as a function of the best prediction model from among several prediction models.

24. A method as claimed in claim 16, wherein said payoff is computed based on one or more repetitive game(s).

25. A method as claimed in claim 5, wherein said deployment is over multiple participant sets each set being determined by selection techniques,

26. A method as claimed in claim 5, wherein participant selection uses incremental learning algorithms and/or predictive techniques and/or learning tools to improve output.

27. A method as claimed in claim 5, wherein incentivisation uses incremental learning algorithms to improve output.

28. A method as claimed in claim 1 using a plurality of marketing research approach designs, a different marketing research approach design being used for each participant based on ranking according to expected gains.

29. A method as claimed in claim 15, wherein said termination condition is based on a threshold on uncertainty or rate of change of uncertainty or information value or rate of change of information value

30. A method as claimed in claim 1, wherein the research approach design consists of one or a combination of an experimental design to study the response to an advertisement, coupon or product recommendation and/or classification of participants and/or survey(s).

31. A method as claimed in claim 1, wherein the research approach design consists of a set of independent sub-sets of research approach designs.

32. A method as claimed in claim 31, wherein the research approach design is deployed incrementally in stages with each stage consisting of one or more independent sub-sets.

33. A method as claimed in claim 4, wherein the incentive offered to the participant is contingent on the timing of response and/or quality of response.

34. The system for automating the design of online marketing research activity, its deployment and the analysis and reporting of the obtained data comprising:
marketing research objectives identification means,
marketing information requirement determination means to meet said marketing research objectives,
research approach design selection means,
target group selection means for effectively deploying said marketing research approach design,
deployment means for deploying said marketing research approach design including dynamically modifying said research approach design and/or target group of participants,
means for collecting and analyzing data, and
means for reporting findings.

35. A system as claimed in claim 34, wherein said marketing research objective identification means is a merchant objective specification tool for selecting from predefined objectives and/or their combinations and/or interrelationships.

36. A system as claimed in claim 34, wherein said requirement determination means is information requirement analysis tool for mapping each said objective to a set of data analysis techniques, identifying associated data requirements, determining which required information is not available in existing data repositories and the desired format of such missing data.

37. A system as claimed in claim 34, wherein said research approach design selection means is a research approach design selection tool for choosing from a repository of research designs based on said marketing information, computed cost of deployment including cost of personalization and incentivisation, and value of marketing information to be obtained.

38. A system as claimed in claim 34, wherein said deployment means is a mechanism for adaptively adjusting the number and selection of participants and/or dynamically modifying said research design to suit an individual participant such that maximum information value is obtained at minimal cost.

39. A system as claimed in claim 35, wherein said merchant objectives specification tool provides means for selecting from predefined objectives including sales forecast, product preference test, advertising campaign effectiveness studies, new product acceptance and potential, pricing studies, study of business trends, desired feature enhancement to a product, market share analysis, studies of coupons, marketing campaign design, and market structure study to spot new opportunities.

40. A system as claimed in claim 36, wherein said information requirement analysis tool incorporates a mechanism for implementing data analysis techniques including conjoint analysis, segmentation using clustering based on attribute importance of product features, and collaborative filtering or demographic segmentation.

41. A system as claimed in claim 36 further including a mechanism for implementing an objective map technique for using a supervised learning technique for analysis of participant information.

42. A system as claimed in claim 37 including means for associating incentive, utility and gain values for each participant with each said research design used.

43. A system as claimed in claim 37 including a mechanism for using previous participant history of purchases, responses to research designs, click-stream information and any other available data.

44. A system as claimed in claim 37 including means for determining said incentives based on the value of information from the participant and the cost of collection of said information including the cost of said incentive.

45. A system as claimed in claim 38 further comprising mechanism for selecting said participants based on cost of reaching the participant, cost of incentives offered to ensure participation, the probability of obtaining a response and the cost of analysing and using the information collected.

46. A system as claimed in claim 38 further comprising means for using adaptive resampling technique for predicting a new participants' class and computing the uncertainty index for each participant.

47. A system as claimed in claim 38 further comprising mechanism for determining said incentives optimally, based upon the history of said participants responses to said research designs, probability of said participant responding to a given incentive, value of information expected to be received and cost of conducting the research on said participant.

48. A system as claimed in claim 38 further including means for incremental participant selection until a specified termination condition is reached.

49. A system as claimed in claim 38 including means for computing the value of the information expected from said participant using Bayes decision theory to compute expected incremental payoff from each participant, the total expected payoff, and the decline in uncertainty.

50. A system as claimed in claim 36, wherein said means for mapping is a mechanism that operates iteratively with merchant interaction.

51. A system as claimed in claim 36, wherein said means for mapping uses an incremental learning mechanism to improve output.

52. A system as claimed in claim 37, wherein a selected one or more out of a plurality of approach means are used to determine required data, said approach means being selected by said merchant based on cost and merit of each approach.

53. A system as claimed in claim 34 further including learning means for identifying desired marketing research objective, determining marketing information required, and selecting the most appropriate research approach design, based on findings and merchant feedback.

54. A system as claimed in claim 36, wherein said existing data repositories are available online either at all times or periodically or at specified time frames.

55. A system as claimed in claim 38 further including means for incorporating participant profile and/or preferences in responding to various research designs as a basis for selection of participants wherein profile includes expected response time, previous history of purchases, usage of coupons, response to advertisements and research designs, click-stream information and any other participant specific information.

56. A system as claimed in claim 38 further including means for incorporating the value of information as a function of the best prediction model from among several prediction models.

57. A system as claimed in claim 49 including means for computing said payoff based on one or more repetitive game(s).

58. A system as claimed in claim 38 further including means for deploying said marketing research approach design over multiple participant sets each set being determined by selection techniques.

59. A system as claimed in claim 38, wherein said participant selection uses incremental learning means and/or predictive mechansim and/or learning tools to improve output.

60. A system as claimed in claim 38 incorporating incremental learning means to improve incentivisation.

61. A system as claimed in claim 34 including a mechanism for using a plurality of marketing research approach designs, a different marketing research approach design being used for each participant based on ranking according to expected gains.

62. A system as claimed in claim 48 further including means for using a threshold on uncertainty or rate of change of uncertainty or information value or rate of change of information value for identifying said termination condition.

63. A system as claimed in claim 34, wherein the research approach design consists of one or a combination of experimental designs to study the response to an advertisement, coupon or product recommendation and/or classification of participants and/or survey(s).

64. A system as claimed in claim 34, wherein said research approach design consists of a set of independent sub-sets of research approach designs.

65. A system as claimed in claim 64, further including means for deploying said research approach design incrementally in stages with each stage consisting of one or more independent sub-sets.

66. A system as claimed in claim 37, wherein the incentive offered to the participant is contingent on the timing of response and/or quality of response.

67. The computer program product comprising computer readable program code stored on a computer readable storage medium embodied therein for automating the design of online marketing research activity, its deployment and the analysis and reporting of the obtained data comprising:
computer readable program code means configured for identifying the desired marketing research objectives,
computer readable program code means configured for determining the marketing information required to meet said marketing research objectives,
computer readable program code means configured for selecting the most appropriate research approach design,
computer readable program code means configured for deciding the target group and costs for effectively deploying said marketing research approach design,
computer readable program code means configured for deploying said marketing research approach design including dynamically modifying said research approach design and/or target group of participants,
computer readable program code means configured for collecting and analyzing data, and
computer readable program code means configured for reporting findings.

68. A computer program product as claimed in claim 67, wherein said computer readable program code means configured for identifying the desired marketing research objectives is a merchant objective specification program code means for selecting from predefined objectives and/or their combinations and/or interrelationships.

69. A computer program product as claimed in claim 67, wherein said computer readable program code means configured for determining the marketing information is an information requirement analysis program code means for mapping each said objective to a set of data analysis techniques, identifying associated data requirements, determining which required information is not available in existing data repositories and the desired format of such missing data.

70. A computer program product as claimed in claim 67, wherein said computer readable program code means configured for selecting the research approach design is research approach design tool program code means for choosing from a repository of research designs based on said marketing information, computed cost of deployment including cost of personalization and incentivisation, and value of marketing information to be obtained.

71. A computer program product as claimed in claim 67, wherein said computer readable program code means configured for deploying is a program code means for adaptively adjusting the number and selection of participants and/or dynamically modifying said research design program code means to suit an individual participant such that maximum information value is obtained at minimal cost.

72. A computer program product as claimed in claim 68, wherein said merchant objectives specification program code means is configured for selecting from predefined objectives including sales forecast, product preference test, advertising campaign effectiveness studies, new product acceptance and potential, pricing studies, study of business trends, desired feature enhancement to a product, market share analysis, studies of coupons, marketing campaign design, and market structure study to spot new opportunities.

73. A computer program product as claimed in claim 69, wherein said information requirement analysis program code means is configured for implementing data analysis techniques including conjoint analysis, segmentation using clustering based on attribute importance of product features, and collaborative filtering or demographic segmentation.

74. A computer program product as claimed in claim 69 including computer readable program code means configured for implementing an objective map technique for using a supervised learning technique for analysis of participant information.

75. A computer program product as claimed in claim 70 including computer readable program code means configured for associating incentive, utility and gain values for each participant with each said research design program code means used.

76. A computer program product as claimed in claim 70 further including computer readable program code means configured for using previous participant history of purchases, responses to research designs program code means, click-stream information and any other available data.

77. A computer program product as claimed in claim 70 further including computer readable program code means configured for determining said incentives based on the value of information from the participant and the cost of collection of said information including the cost of said incentive.

78. A computer program product as claimed in claim 71 further comprising computer readable program code means configured for selecting said participants based on cost of reaching the participant, cost of incentives offered to ensure participation, the probability of obtaining a response and the cost of analysing and using the information collected.

79. A computer program product as claimed in claim 71 further comprising computer readable program code means configured for using adaptive resampling technique for predicting a new participants' class and computing the uncertainty index for each participant.

80. A computer program product as claimed in claim 71 further comprising computer readable program code means configured for determining said incentives optimally, based upon the history of said participants responses to said research design program code means, probability of said participant responding to a given incentive, value of information expected to be received and cost of conducting the research on said participant.

81. A computer program product as claimed in claim 71 further including computer readable program code means configured for incremental participant selection until a specified termination condition is reached.

82. A computer program product as claimed in claim 71 including computer readable program code means configured for computing the value of the information expected from said participant using Bayes decision theory to compute expected incremental payoff from each participant, the total expected payoff, and the decline in uncertainty.

83. A computer program product as claimed in claim 69, wherein said computer readable program code means configured for mapping is a mechanism that operates iteratively with merchant interaction.

84. A computer program product as claimed in claim 69, wherein said computer readable program code means configured for mapping uses an incremental learning mechanism to improve output.

85. A computer program product as claimed in claim 69 further incorporating program code means for selecting one or more out of a plurality of computer readable program code approach means configured for determining required data, said approach means being selected by said merchant based on cost and merit of each approach.

86. A computer program product as claimed in claim 67 further including computer readable program code learning means configured for identifying desired marketing research objective, determining marketing information required and selecting the most appropriate research approach design program code means, based on findings and merchant feedback.

87. A computer program product as claimed in claim 65, wherein said existing data repositories are available online either at all times or periodically or at specified time frames.

88. A computer program product as claimed in claim 67 further including computer readable program code means configured for incorporating participant preferences in responding to various research designs and/or participant profile program code means as a basis for selection of participants wherein profile includes expected response time, previous history of purchases, usage of coupons, response to advertisements and research designs, click-stream information and any other participant specific information.

89. A computer program product as claimed in claim 71 further including computer readable program code means configured for incorporating the value of information as a function of the best prediction model from among several production models.

90. A computer program product as claimed in claim 82 including computer readable program code means configured for computing said payoff based on one or more repetitive game(s).

91. A computer program product as claimed in claim 71 further including computer readable program code means configured for deploying said marketing research approach design program code means over multiple participant sets each set being determined by selection techniques.

92. A computer program product as claimed in claim 71, wherein said program code means for participant selection uses incremental learning algorithms and/or predictive techniques and/or learning tools to improve output.

93. A computer program product as claimed in claim 71 incorporating computer readable program code means configured to use incremental learning to improve incentivisation.

94. A computer program product as claimed in claim 67, wherein a plurality of marketing research approach design program code are used, a different marketing research approach design being used for each participant based on ranking according to expected gains.

95. A computer program product as claimed in claim 81, wherein said computer readable program code means is configured for using a threshold on uncertainty or rate of change of uncertainty or information value or rate of change of information value for identifying said termination condition

96. A computer program product as claimed in claim 67, wherein said research approach design program code means consists of one or a combination of experimental design program code means for studying the response to an advertisement, coupon or product recommendation and/or classification of customers and/or survey(s).

97. A computer program product as claimed in claim 67, wherein said research approach design program code means consists of a set of independent sub-sets of research approach designs.

98. A computer program product as claimed in claim 97, wherein said research approach design program code means is deployed incrementally in stages with each stage consisting of one or more independent sub-sets.

99. A computer program product as claimed in claim 70 further including program code means for offering said incentive to the participant contingent on the timing of response and/or quality of response.
